(19) United States
(12) Patent Application Publication
(10) Pub. No.: US 2004/0123914 A1
(43) Pub. Date: Jul. 1, 2004

(54) Water hose with internal partitioning plates

(76) Inventor: Gordon Chih, Changhua Hsien (TW)

Correspondence Address: TROXELL LAW OFFICE PLLC, SUITE 1404, 5205 LEESBURG PIKE, FALLS CHURCH, VA, 22041, US

(21) Appl. No.: 10/609,648

(22) Filed: Jul. 1, 2003

(30) Foreign Application Priority Data
Dec. 27, 2002 (TW) 091221315

(51) Int. Cl. F16L 11/00

(52) U.S. Cl. 138/115; 138/116; 138/117

(57) ABSTRACT

Water hose with internal partitioning plates, including a main body and at least one support section. The main body is a hollow tube body made of soft material with a predetermined length. One side of the support section is fixed on a predetermined portion of inner wall of the main body to divide an interior of the main body into at least two passages communicating with each other. The support section is a polygonal body with a length corresponding to that of the main body. After wound, the water hose has small volume without occupying much space and the passages are not compressed, still permitting the water to flow therethrough. After the water hose is pulled out by a certain length and the water flows therethrough, the water pressure makes the pulled out section of the water hose expanded into a circular tubular shape for a user's hand to easily hold.

### BACKGROUND OF THE INVENTION

The present invention is related to a water hose, and more particularly to a water hose or hydrant hose with internal partitioning plates.

A conventional water hose is substantially made of elastic material and has a predetermined length and thickness. When stored, the water hose is wound into a large volume and heavy weight state. It is inconvenient to transfer or carry such water hose. Also, much space is necessary for storing such water hose.

In order to solve the above problem, a belt-like soft water hose has been developed. Such water hose is like hydrant hose and made of soft material and has thinner thickness. There are two kinds of structures of such water hose. One is simply made of soft plastic or rubber material. The other is made of soft plastic or rubber material and coated with a fabric layer to form a belt-like soft fabric water hose. The above two kinds of belt-like soft water hoses have light weight. After wound, the inner walls of the water hose attach to each other so as to minimize the volume. Accordingly, it is convenient to transfer and store such water hose.

Referring to FIG. 1, in use, one end of the conventional water hose 81 or belt-like soft water hose is connected with a water source such as a faucet for conducting the water to another place. When stored, the water hose is wound on a reel.

With respect to the conventional water hose 81, when pulled out and bent or compressed, the water flow will be cut off at the bent section 811. Moreover, when totally unwound and used, the conventional water hose 81 will be continuously swung and turned and repeatedly twisted. After used and it is desired to wind and collect the water hose 81, it is necessary to laboriously throw straight the water hose and then wind and collect the water hose 81 in order.

With respect to the belt-like soft water hose, when stored, the volume of the water hose is small. However, when using such water hose, it is necessary to totally pull out the water hose. Otherwise, the water flow will be obstructed in the wound part of the water hose. In other words, even if it is only necessary to conduct the water through a short distance, the water hose still must be totally pulled out. This is quite inconvenient. Also, in the case that a section of the water hose is bent or compressed, the water flow will be cut off.

Furthermore, the belt-like soft water hose such as hydrant hose must be totally pulled out for extinguishing a fire. It costs considerably long time to completely pull out the water hose. As a result, it often takes place that the water hose cannot be used to extinguish the fire in time.

In practice, it is often seen that when a fire engine arrives the fire scene, a fireman must first unwind and throws out the water hose and then connect the water hose with a water source for extinguishing the fire. In some cases, there is no enough space for throwing out the water hose. This will also delay the fire extinguishing duty.

FIGS. 2 and 3 show an improved flat water hose 91. At least one partitioning plate 92 is disposed in the water hose 91. The length of the partitioning plate 92 is corresponding to that of the water hose 91. Two sides of the partitioning plate 92 are fixed on inner wall of the water hose 91 to support the same. By means of the partitioning plate 92, in both the part of the water hose 91 wound on a reel 93 and the part of the water hose 91 unwound from the reel 93, the water flow will not be obstructed due to bending or compression.

However, it is known that a human hand is adapted to hold a circularly profiled article such as a pen, a golf club, a racket handle, a steering wheel and a gardening sprinkler handle. In other words, a circularly profiled shape better meets the human engineering of the human hand. The two sides of the partitioning plate 92 are fixed on inner wall of the flat water hose 91, so that when the water hose 91 suffers an internal water pressure, the water hose 91 will still keep having a flat rectangular shape. Therefore, the flat water hose 91 fails to meet human engineering and it is uncomfortable and uneasy to hold the flat water hose 91. Also, it is hard to connect the flat water hose 91 with a circular gardening sprinkler handle. Do you think it is comfortable in using a circular shape with a rectangular shape? Notwithstanding the flat water hose 91 has early finished research and design. As consumers still cannot accept the rectangular shape of the flat water hose 91′. The flat water hose 91 can be hardly commercially accepted. Furthermore, the flat water hose 91 with rectangular cross-section cannot be directly fitted with a commercially available circular fast tube connector 82 as shown in FIG. 4.

With respect to connection between the conventional water hoses and a tube connector, the conventional water hoses have shortcomings as follows:

1. The belt-like soft fabric water hose includes separable gum-made inner layer and fabric outer layer. Such water hose is only adaptable to special tube connector. A general domestic or gardening circular fast tube connector is not applicable to such water hose. Moreover, it necessitates special skill and tool to connect the special tube connector with the water hose. For example, a metal tube must be used to clamp the belt-like soft fabric water hose. This cannot be performed by a consumer. In other words, when manufactured, the tube connector must be mounted on the belt-like soft fabric water hose by the manufacturer.

2. With respect to the flat water hose 91, the two sides of the partitioning plate 92 are fixed on inner wall of the flat water hose 91 to define several rectangular cross-sections. Such flat water hose 91 is also only adaptable to special tube connector. A general domestic or gardening circular fast tube connector is not applicable to such flat water 91 hose. A consumer can hardly connect the special tube connector with the flat water hose.

With respect to using life, in case any part of the above belt-like soft fabric water hose or flat water hose 91 is broken and water leaks from the water hose, a consumer can hardly cut off the broken part of the water hose and reconnect the water hose. In other words, an about 15-30 meter length water hose will become useless. This leads to waste of resource.

### SUMMARY OF THE INVENTION

It is therefore a primary object of the present invention to provide a water hose with internal partitioning plates. After wound, the water hose has small volume so that the water hose can be easily carried and stored. In addition, the water hose can be used without being totally pulled out. Moreover, when bent or compressed, the water flowing through the water hose will not be obstructed. When the water flows through the water hose, the water pressure makes the pulled out section of the water hose expanded into a circular tubular shape for a user's hand to easily hold.

It is a further object of the present invention to provide the above water hose. A user himself can easily and quickly cut off a part of the water hose for connecting the water hose with a gardening fast tube connector.

It is still a further object of the present invention to provide the above water hose. In case any part of the water hose is broken, a consumer himself can easily cut off the damaged part and reconnect the water hose with the tube connector. Therefore, the waste of resource is avoided.

According to the above objects, the water hose with internal partitioning plates of the present invention includes a main body and at least one support section. The main body is a hollow tube body made of soft material with a predetermined length. One side of the support section is fixed on a predetermined portion of inner wall of the main body to divide an interior of the main body into at least two passages communicating with each other.

The present invention can be best understood through the following description and accompanying drawings wherein:

### BRIEF DESCRIPTION OF THE DRAWINGS

FIG. 1 shows the use of a conventional water hose;

FIG. 2 is a perspective view of a part of conventional flat water hose;

FIG. 3 shows the use of the conventional flat water hose;

FIG. 4 is a perspective exploded view showing that a conventional circular fast tube connector is connected with a water hose;

FIG. 5 is a perspective view of a part of a first embodiment of the present invention;

FIG. 6 is a cross-sectional view of a second embodiment of the present invention;

FIG. 7 is a cross-sectional view of a third embodiment of the present invention;

FIG. 8 is a perspective view of the first embodiment of the present invention in a wound state;

FIG. 9 is a sectional view taken along line I-I of FIG. 8;

FIGS. 10 and 11 show the use of the first embodiment of the present invention;

FIGS. 12A and 12B are perspective views showing that the support sections of the first embodiment of the present invention are cut; and

FIG. 13 is a cross-sectional view of a fourth embodiment of the present invention.

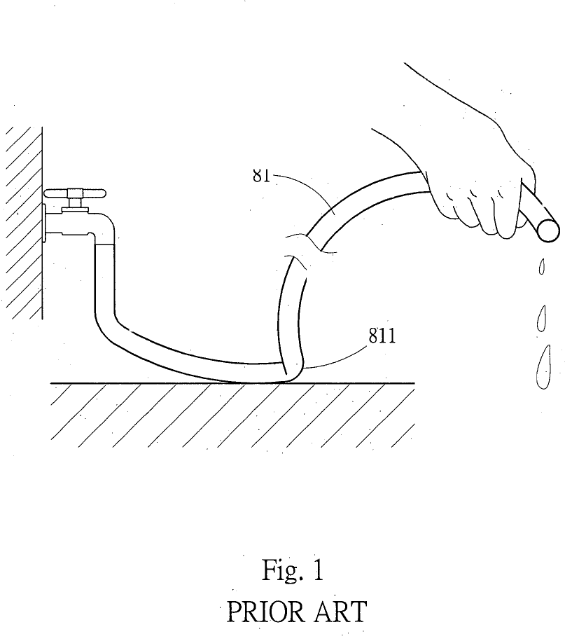

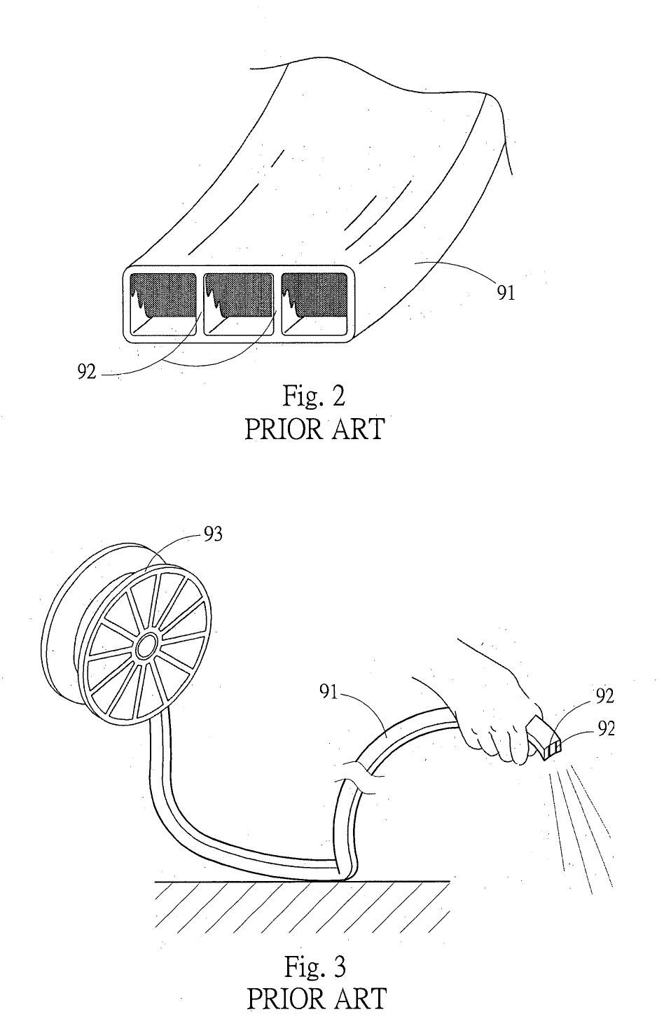

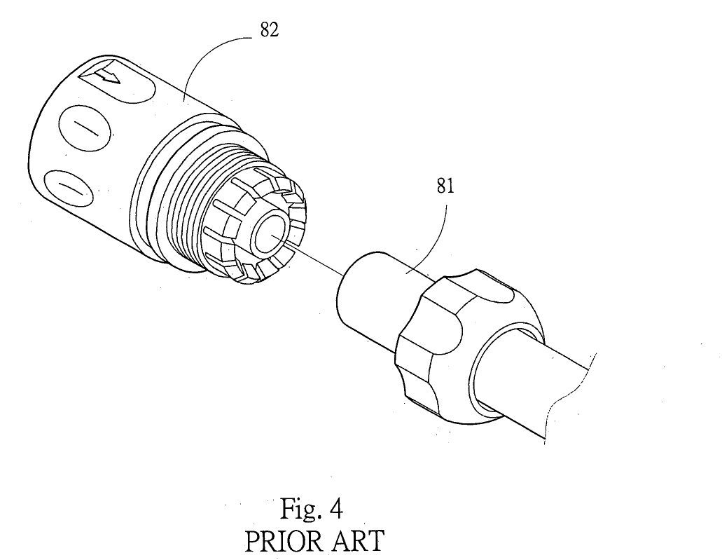

### DETAILED DESCRIPTION OF THE PREFERRED EMBODIMENTS

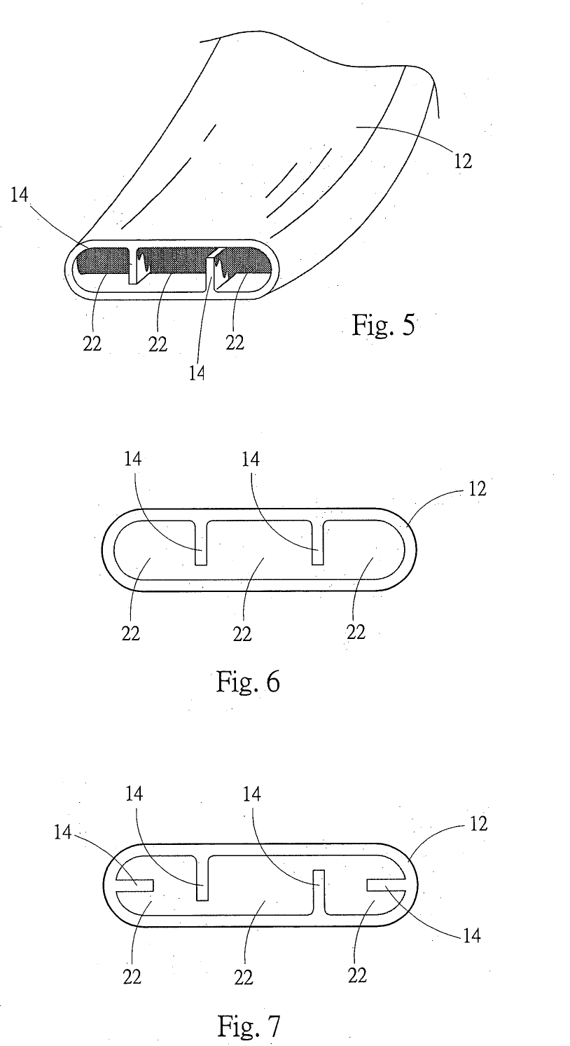

Please refer to FIGS. 5 to 7. The water hose with internal partitioning plates of the present invention includes a main body 12 and at least one support section 14.

The main body 12 is a hollow tube body made of soft material with a predetermined length.

One side of the support section 0.14 is fixed on a predetermined portion of inner wall of the main body 12 to divide the interior of the main body 12 into at least two passages 22 communicating with each other.

According to the above arrangement, the water hose of the present invention has the following advantages:

1. After wound and collected, the water hose still has small volume and light weight. In general, the inner diameter of a gardening water hose is about 12 mm and the outer diameter thereof is about 19-22 mm. After wound, the water hose of the present invention forms a rectangle with a height about ⅔ less than the thickness of the general gardening water hose. In the case of equal length, the volume of the present invention is about ⅔ less than that of the conventional water hose. Therefore, it is convenient to transfer the water hose of the present invention.

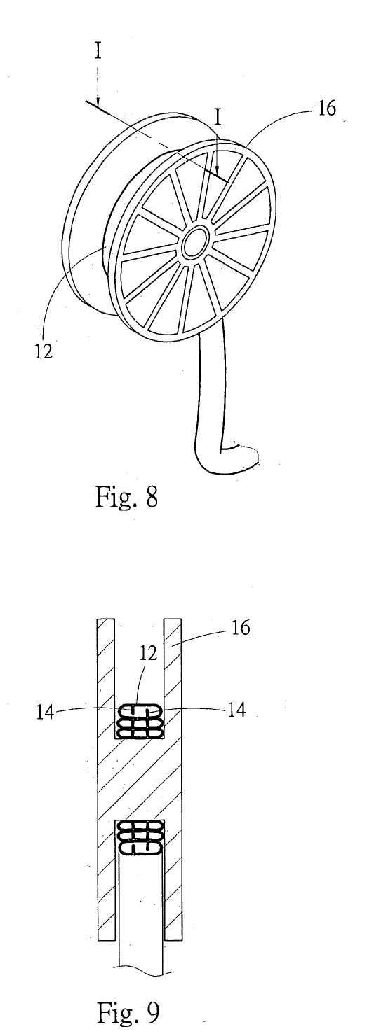

2. Referring to FIGS. 8 and 9, when the main body 12 is wound on a reel 16, the water can still flow through the interior of the main body 12 without entirely pulling out the water hose.

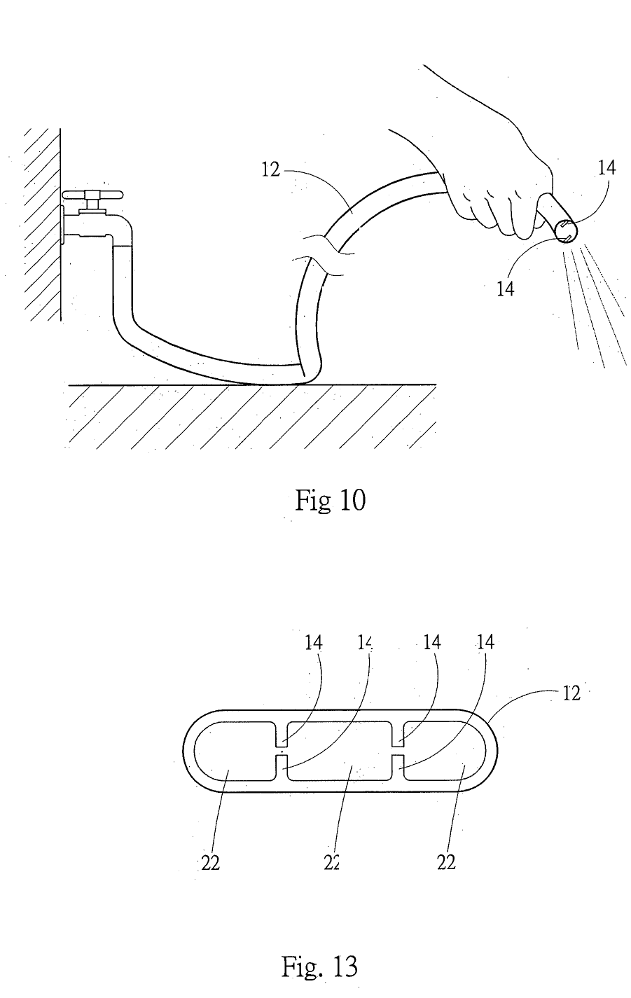

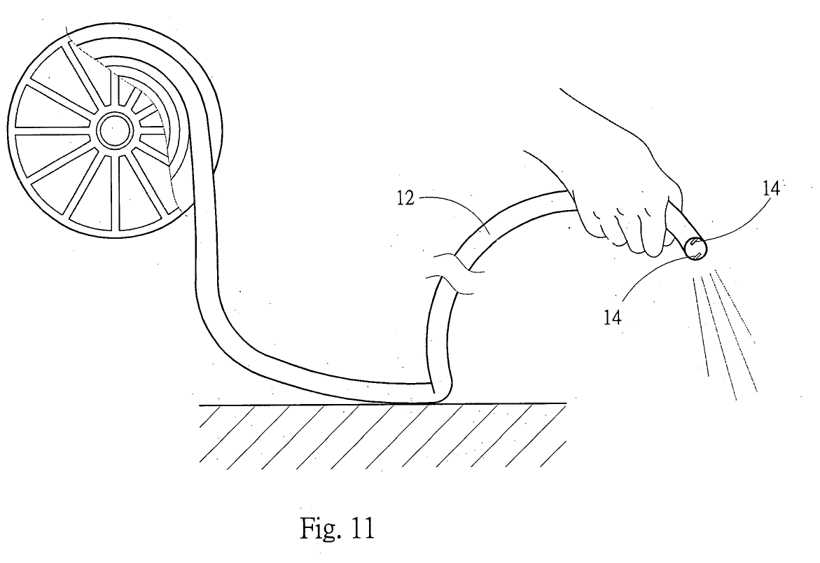

3. Referring to FIGS. 10 and 11, when the pulled out section of the main body 12 is bent or compressed, the water flow in the main body. 12 will not be obstructed. On the other hand, the pressure of the water flow will expand the pulled out section of the main body 12 into a circular tubular shape. Accordingly, a user can easily hold the water hose with hands. This meets human engineering.

4. In manufacturing, the inner cross-sectional area of the water hose of the present invention can conform with the inner cross-sectional area of a general gardening water hose (inner diameter of which is about 12 mm). Accordingly, the flow quantity of the water hose of the present invention is' about equal to that of the general gardening water hose.

5. When the present invention is applied to a hydrant hose, it is unnecessary to totally pull out the water hose for extinguishing the fire. Therefore, the fire can be extinguished in time. Moreover, the water flow makes the pulled out section of the water hose expanded into a circular tubular shape as a conventional circular hydrant hose being used.

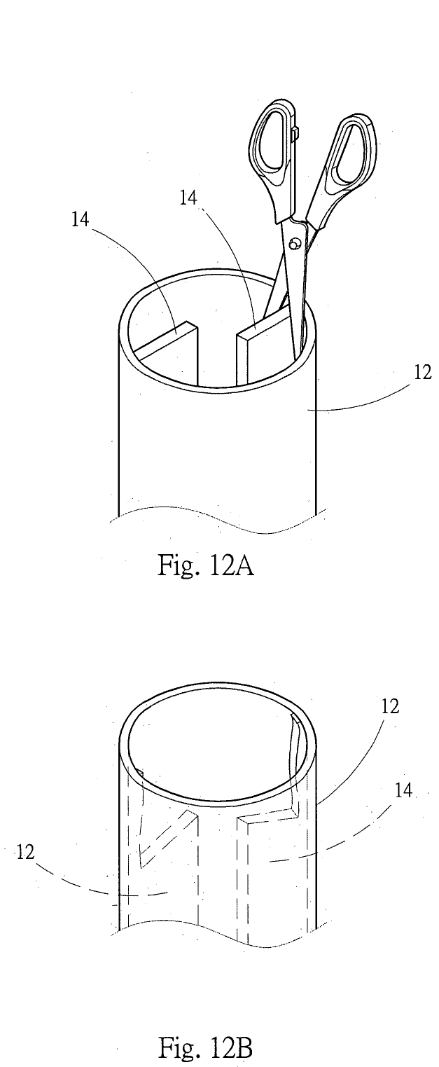

6. Please refer to FIG. 12. After formed, a consumer himself can easily use a scissors to cut off some portion of the support section 14 of one end or two ends of the main body 12. Accordingly, without using any additional special tube connector, one end or two ends of the main body 12, can be directly adapted to a common circular tube connector. Therefore, it is quite convenient and elastic to use the water hose of the present invention. Certainly, the cut off part of the support section 14 may be not so smooth and regular. However, the common tube connector has a fastening means so that the water will not leak from the irregular part.

7. In case the water hose of the present invention is broken at the tube connector, a consumer himself can easily cut off the damaged part and reconnect the tube connector with the water hose. Therefore, the waste of resource is avoided.

8. In use, the water pressure can make the water hose of the present invention expanded into a circular tubular shape meeting human engineering. This eliminates the shortcomings existing in the conventional water hoses. Also the water hose of the present invention gets together with the merits of all kinds of the conventional water hoses.

In the water hose of the present invention, the direction of each passage 22 is corresponding to the lengthwise direction of the main body 12.

In the water hose of the present invention, the support section 14 is a polygonal body with a length corresponding to that of the main body 12.

Alternatively, in the water hose of the present invention, the support section 14 is a quadrangular body with a length corresponding to that of the main body 12.

FIG. 13 shows another embodiment of the present invention, in which two pairs of the support sections 14 are oppositely disposed in the water hose of the present invention.

In manufacturing, the cross-section of the water hose of the present invention can be polygonal such as rectangular. The present invention is made of soft material so that when the water flows through the water hose, the water pressure can make the water hose of the present invention expanded into a circular tubular shape. When the water hose is free from the water pressure, the water hose is restored into the flat shape. Accordingly, in the case that the water hose of the present invention has a rectangular cross-section, the water hose can be conveniently and quickly wound into a small volume state. Moreover, in winding procedure, the water hose itself can regularly twist. Therefore, it will not consume much time and strength to wind and collect the water hose and it is unnecessary to continuously throw the water hose as in the winding procedure of the conventional water hose 81.

The above embodiments are only used to illustrate the present invention, not intended to limit the scope thereof. Many modifications of the above embodiments can be made without departing from the spirit of the present invention.

What is claimed is:

1. Water hose with internal partitioning plates, comprising:
a main body which is a hollow tube body made of soft material with a predetermined length; and
at least one support section, one side of the support section being fixed on a predetermined portion of inner wall of the main body to divide an interior of the main body into at least two passages communicating with each other.

2. Water hose with internal partitioning plates as claimed in claim 1, wherein the direction of each passage is corresponding to a lengthwise direction of the main body.

3. Water hose with internal partitioning plates as claimed in claim 2, wherein the support section is a polygonal body with a length corresponding to that of the main body.

4. Water hose with internal partitioning plates as claimed in claim 2, wherein the support section is a quadrangular body with a length corresponding to that of the main body.

5. Water hose with internal partitioning plates as claimed in claim 1, wherein two pairs of the support sections are oppositely disposed in the water hose.

6. Water hose with internal partitioning plates as claimed in claim 5, wherein the direction of each passage is corresponding to a lengthwise direction of the main body.

7. Water hose with internal partitioning plates as claimed in claim 6, wherein each support section is a polygonal body with a length corresponding to that of the main body.

8. Water hose with internal partitioning plates as claimed in claim 1, wherein each support section is a quadrangular body with a length corresponding to that of the main body.

9. Water hose with internal partitioning plates as claimed in claim 1, wherein the cross-section of the main body is polygonal.

10. Water hose with internal partitioning plates as claimed in claim 9, wherein the cross-section of the main body is rectangular.
